(19) United States
(12) Patent Application Publication
(10) Pub. No.: US 2006/0227316 A1
(43) Pub. Date: Oct. 12, 2006

(54) Three-dimensional imaging device

(76) Inventor: Phillip Gatt, Longmont, CO (US)

Correspondence Address: MCDERMOTT WILL & EMERY LLP, 18191 VON KARMAN AVE., SUITE 500, IRVINE, CA, 92612-7108, US

(21) Appl. No.: 11/099,715

(22) Filed: Apr. 6, 2005

(51) Int. Cl. G01C 3/08

(52) U.S. Cl. 356/5.09; 356/4.01; 356/5.01; 356/5.11

(57) ABSTRACT

A laser radar capable of measuring range to a target at many simultaneous points and with variable resolution is disclosed. Unlike conventional range sensors the device does not require short optical pulses or high electronics bandwidths to function. The disclosed invention uses frequency-modulated CW (FMCW) lasers, coherent detection, and low bandwidth video cameras to simultaneously measure range to a large number of points. The invention further permits varying the range resolution, range depth coverage, and eliminating Doppler induced range ambiguities by varying the frequency modulation parameters.

### BACKGROUND OF THE INVENTION

1. Field of the Invention

This invention is in the field of imaging devices and, more specifically, to systems and methods for measuring range to a target at many points and with variable resolution.

2. Relevant Background

Measuring the distance (range) from a sensor location to a remotely located target is important in many applications, including geodimetry, military ranging applications, and consumer applications, such as measuring the distance from a ball location to a golf hole or proper focusing of cameras. As a result numerous techniques have been developed to make such measurements using ultrasound, radar, passive optical devices, and laser techniques. Of these techniques lasers have many advantages, in particular because the laser beam can be confined to a small spot over considerable distances and hence it can be made to reflect from a well-defined small area at the target. Radar and ultrasonic devices by contrast have beams that diffract quickly and hence scatter radiation from a wide area making it difficult to determine with certainty where a given received signal originated.

All sensors require a measurement bandwidth commensurate with the sensor's design range resolution, ΔR. To first order this is given by the relation, ΔR˜c/2B, where c is the speed of light (approximately 3×10⁸ m/s) and B is the sensor's (transmit and receive) effective bandwidth. Lasers are inherently very wideband devices compared to their RF counterparts, consequently very high bandwidths are possible leading to achievable range resolution on the order of 100 micrometers or less. However, the receiver should have a commensurate bandwidth. If signal demodulation occurs in the electronics then the maximum sensor resolution is typically driven by the available electronics bandwidth. On the other hand, if the demodulation is performed optically the electronics do not necessarily need to have a bandwidth commensurate with the transmitted waveform.

The most common laser range finders use pulsed laser transmitters that produce a short pulse of light. The “time of flight” t_{TOF} taken for such a pulse to travel to the target and back to a receiver is given by t_{TOF}=2R/c, where R is the target range and c is the speed of light (approximately 3×10⁸ m/s). By measuring the time of flight one can therefore determine the target range from the above expression. If the temporal width of the pulse is tₚ, the range resolution of the sensor is given approximately by ΔR=c·tₚ/2. This means that to resolve two objects separated in range by ΔR, the pulse width should be shorter than 2ΔR/c. For example, if the pulse width is 1 nanosecond (ns) the corresponding range resolution is approximately 15 cm.

A fundamental issue with short pulse time-of-flight devices is that requirements on short pulses implies the need for high bandwidth receiver electronics. Receiver bandwidth BWᵣ is given approximately by the inverse relationship BWᵣ=1/tₚ, which in the case of 1 ns pulses means BWᵣ=1 GHz. This means that very high speed electronics are required to capture and process signals from time of flight range finders.

An alternative method of using laser devices is to modulate the transmitted signal and synchronously detect a modulated return signal. Modulation can be amplitude (for example a sinusoidal variation of laser power at a frequency fₘ), phase (e.g. sinusoidal modulation of the laser phase at a frequency fₘ), or using predetermined code patterns. A well known code technique uses pseudo-random number (PRN) codes that transmit a sequence of random, but predetermined, pulses and uses a receiver that correlates received signal patterns with the transmitted code pattern. The correlation match indicates target range. One advantage with these modulated approaches is that they do not require high peak power laser pulses to be produced and transmitted. Although both detection methods require a similar number of photons to be received for detection to take place, whereas a pulsed time of flight range finder relies on high power to produce sufficient signal in a short time, modulated devices instead rely on integrating a small number of photons over a relatively long time period.

While these modulation techniques are frequently used in practice, they do not fundamentally circumvent the need for relatively high electronics bandwidth B=c/2ΔR. On the other hand, the linear FM modulated optical waveform can be modulated and demodulated optically, rather than electronically. When the optical waveform is modulated and demodulated optically, the electronics bandwidth for both the transmitter and receiver can be made arbitrarily small when the dwell time is allowed to be arbitrarily large.

All of the noted approaches present a significant problem when one desires to measure the range not to a single target, but to multiple target points. This is a common desire, for example, in measuring 3-dimensional (“3D”) features of an object. Specifically, the need to perform such 3D mapping is increasingly felt with military systems that aim to identify targets viewed, for example, by reconnaissance aircraft. Range imaging is conventionally done by scanning. A laser beam is transmitted off a scanning device, frequently a pair of gimbaled mirrors that can point the beam to a desired angle in two angular dimensions. A range measurement is taken and the scanner steps the beam to a different angle location. By such point-to-point interrogation an “angle-angle-range” (AAR) image can be built up over time using a “single-pixel” range finder. Building high bandwidth devices for a single pixel sensor is not difficult and this approach frequently works well. At the same time, a significant drawback is that building up images in this manner can take substantial time with speed limitations imposed by transit time to and from the target, as well as scanner inertia. A scanner may be limited to for example 1000 steps per second, in which case building up a 100×1100 pixel image would take 10 seconds. If the sensor or target is moving, scanning may also produce highly distorted images and consequent difficulty in unambiguous identification of objects. Examples of scanned imaging systems are numerous and include those described in U.S. Pat. No. 5,682,229 to Wangler and U.S. Pat. No. 5,715,044 to Hayes, hereby incorporated by reference.

For the above stated reasons there is substantial interest in devising “flash” imagers that can capture AAR images of entire scenes without scanning. The primary difficulty in this case is that using conventional techniques as described above, building many channels (such as 1,000 or 10,000) of sensors that operate in parallel with bandwidths of, for example, 100-1000 MHz is not simple or inexpensive. Much effort is currently devoted to such devices and is generally centered around the fabrication of special detector arrays with built-in read-out integrated circuits (ROIC) that perform processing of individual pixels in real time in parallel. The cost of such devices is currently extremely high and it is not presently clear whether sufficient markets exist that will bring the cost down to levels where widespread deployment outside of specialized military applications will be possible. Examples of several systems of this type can be found for example in SPIE Proceedings vol. 5088 (2003), hereby incorporated by reference. A flash imaging system using chirped amplitude modulation that requires high bandwidth and relatively complex optics and processing is described in U.S. Pat. No. 5,877,851 to Stann et al., hereby incorporated by reference. It is important to note that this patent uses the term “FM-CW” not in the context of chirping the optical frequency of the laser source but to impose a sinusoidal amplitude modulation with a frequency that is chirped. The distinction is important for two reasons: amplitude modulation by definition does not make use of the full power available from a light source; the method also does not permit optical heterodyne detection and hence results in a system with reduced sensitivity and less immunity to interference from stray light, such as sunlight. Other flash imaging systems that use pulsed or amplitude modulated light beams in conjunction with various types of modulators placed in front of a multi-pixel detector array are described in U.S. Pat. No. 4,935,616 to Scott, U.S. Pat. No. 6,707,054 to Ray, hereby incorporated by reference, and in the references therein.

An alternative method for carrying out range measurements that has the potential to achieve high resolution range measurements without the need for high speed electronics uses linearly chirped FM modulation of the transmitted optical carrier and optical demodulation of the received signal to produce low bandwidth interference signals. The idea is to linearly chirp the frequency of the laser over a time period that is long enough as compared to the reciprocal bandwidth of the transmit waveform. The frequency of the transmitted light is then given by f₀+(df/dt)·t, where f₀ is the un-chirped frequency, (df/dt) is the frequency chirp rate, and t is the time referenced to zero at the beginning of the chirp. At the time of return from a target at range R the frequency of the optical echo is consequently f₀+(df/dt)·(t+2R/c). By heterodyning the return signal with the laser one can detect the difference f_{IF} between these frequencies, which is f_{IF}=(2R/c)·(df/dt). Consequently a range measurement has been converted into a frequency measurement. Furthermore, the chirp rate (df/dt) can be arranged such that the difference frequencies of interest fall in a convenient low frequency regime.

This approach has been demonstrated with single point sensors by a number of researchers, see for example U.S. Pat. No. 4,721,385 to Jelalian, hereby incorporated by reference. These demonstrations typically use semiconductor diode lasers as the transmitter because of the simplicity of chirping. Diode lasers shift frequency with temperature and drive currents alter temperature. Thus, simply driving the diode laser with a current ramp waveform produces a linearly chirped waveform. While chirp rates vary for different devices, typical values are 1-2 GHz of frequency shift for each 1 mA of current change for common types of low power diode lasers.

A related way of performing the same type of measurement has been described in the literature, see for example Peter J. deGroot and Gregg M. Gallatin, “Three-dimensional imaging coherent laser radar array”, Optical Engineering 28, 456 (1989) and Toshihiko Yoshino et al., “Laser diode feedback interferometer for stabilization and displacement measurements”, Applied Optics 26, 892 (1987), hereby incorporated by reference. This technique uses so-called self-mixing wherein the target return signal is injected into the transmitter laser and causes modulation of the laser at the difference frequency. Because it is in principle a simple device to make it has been proposed that imagers can be built using arrays of self-mixing laser sensors (see for example U.S. Pat. No. 6,233,045 to Suni, hereby incorporated by reference). However, this would require building large 2-dimensional arrays of lasers, which is very expensive. A further complication is that self-mixing sensors require single-frequency operation for stable performance and arrays of such devices, for example arrays of DFB or DBR type diode lasers, appear not to have been built. A modified version of a self-mixing sensor that also describes single point measurements is described in U.S. Pat. No. 6,100,965 to Nerin, hereby incorporated by reference.

### SUMMARY OF THE INVENTION

Briefly stated, the present invention involves a three dimensional range imaging device having a light source that outputs a light beam with a waveform having a linear frequency chirp. Splitting optics coupled to the light beam split the light beam into a transmission portion for illuminating a scene and a local oscillator portion. Mixing optics output a mixed beam comprising scattered light from the illuminated scene coherently mixed with the local oscillator portion of the light beam. A plurality of detector elements, wherein each detector element is optically coupled to the mixing optics to receive a portion of the mixed beam corresponding to a scene point. Each detector element generates an output signal that comprises a summation of sinusoidal component signals. The sinusoidal component signals have unique frequencies corresponding to the range of the detected targets. A signal processor receives the output signal from each of the plurality of detectors and determines the frequencies of the sinusoidal component signals to determine a range or multiple ranges to each scene point or multiple scene points.

### BRIEF DESCRIPTION OF THE DRAWINGS

FIG. 1 illustrates a prior art system for measuring range with a frequency chirp;

FIG. 2 illustrates a specific embodiment of the invention;

FIG. 3 illustrates the generation of local oscillator light to overlap with received light;

FIG. 4 illustrates a typical detector array configuration;

FIG. 5 illustrates the use of a spherical wave to generate a matched local oscillator beam;

FIG. 6 illustrates the use of a phase screen to generate an optimally matched local oscillator beam;

FIG. 7 illustrates an embodiment of the system that allows for additional elements to be incorporated into the transmit or local oscillator beams; and

FIG. 8 illustrates the change in the form of the transmitted and received signals in the presence of a large Doppler shift.

### DETAILED DESCRIPTION OF THE PREFERRED EMBODIMENTS

The invention utilizes a linear frequency chirped laser source, a high speed camera, and coherent detection receiver to produce variable resolution (range and angle) three-dimensional (“3D”) imagery. The specific implementations of the invention described herein can support very high bandwidth (>1 THz) optical waveforms. At the same time the high bandwidth signal demodulation is performed optically, thus enabling relatively low bandwidth detector and receiver electronics (such as <100 kHz), further enabling the use of high-speed digital cameras for image acquisition. As used herein, the term “light” means electromagnetic energy in a spectral range from far infrared (IR) to extreme ultraviolet (UV). Many of the specific examples use coherent electromagnetic energy sources, however, the degree of coherency may be selected to meet the needs of a particular application.

Advantages of the present invention include a scaleable and reconfigurable architecture with simple trade-offs between field of view (“FOV”), frame-rates, range-resolution, electronics bandwidth, and range-search interval. Current sensors have a fixed electronics bandwidth (i.e., range resolution) and a fixed number of samples for each pixel (i.e., range search interval). In contrast, the present invention allows all of these variables to be adjusted on the fly. One can, in principle, start with a very long range search interval (“RSI”) with a low resolution waveform and a simultaneously large FOV. Using this low-resolution wide-angle image as a starting point, one can zoom in on both range and FOV to produce a much higher resolution image over of a portion of the scene. This flexible approach allows a single “smart sensor” design to be reconfigured “on the fly” for a wide variety of military and commercial applications. In essence, the range-resolution can be adjusted on the fly at the expense of the range search interval, such that a fixed number of resolution elements is maintained. This allows the sensor to be operated, first with a coarse resolution to find or spot objects, and subsequently adjusted to a higher resolution around the target zone detected in the coarse resolution mode. Ultimately the resolution is limited by how far the utilized laser can be tuned (for example ˜5 THz corresponding to a 30 μm range resolution). FOV zoom is also conceived to increase the pixel sample frequency and thus increasing the number of resolvable range resolution elements for each pixel. Variable frame rates facilitate a reconfigurable range resolution. For example if the frame rate is doubled, the dwell time is increased by a factor of two and the number of range-resolution elements is increased by a factor of two.

Other advantages of the present invention include:
A 1.5 μm distributed feedback laser (DFB) diode may be used to provide an eye-safe wavelength and enable the use of low-cost commercially available components developed for the telecom industry.
Small, such as less than 1 cm, apertures, enabling a compact lightweight sensor.
Flood illumination and detection over the FOV eliminating the need for intra-frame scan and further reducing sensor size, weight and power.
The laser power is transmitted with 100% duty cycle, enabling full utilization of the developed laser power, a 3 dB advantage over amplitude modulation techniques, further enabling a compact lightweight sensor with low power consumption.
Optical mixing in the FMCW approach reduces the detector and preamplifier bandwidth requirements, which can be much smaller than the signal bandwidth (3 to 15 GHz for 5 to 1 cm resolution).
Near quantum limited coherent (i.e., heterodyne) detection, as opposed to direct detection, minimizing the transmitted power requirements. Coherent detection is the technology for optical signal processing (demodulation) which enables the use of low bandwidth receivers (i.e., high-speed digital IR cameras).

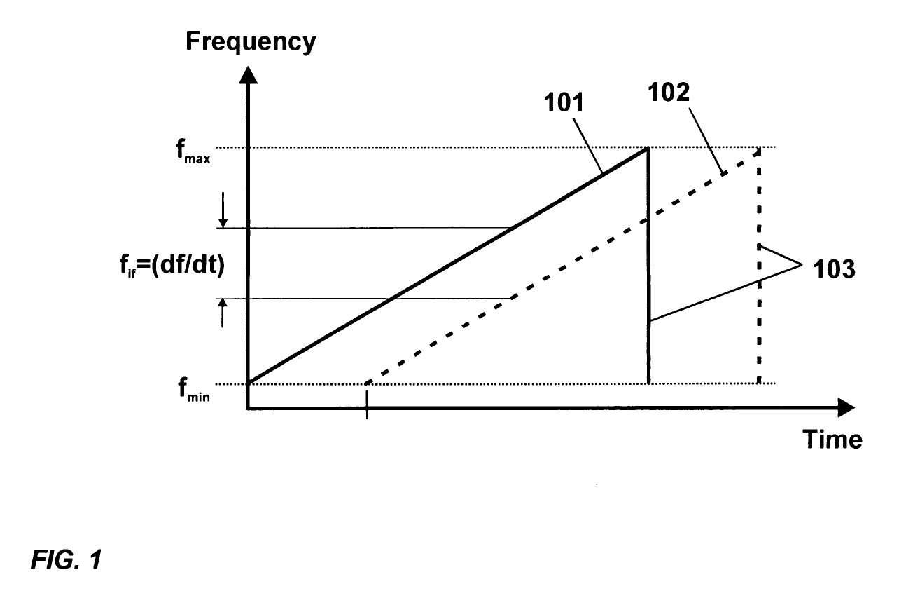

FIG. 1 shows a prior art system for measuring range with a frequency chirp to illustrate the principle of how measurements are performed. A laser is modulated in such a way that it produces a frequency that varies linearly with time as illustrated by line 101 between a minimum value fₘᵢₙ and a maximum value fₘₐₓ. The frequency chirp rate is given by (df/dt) corresponding to the slope of line 101. This chirped light beam is transmitted to a target and returns after a time τ with a frequency chirp as illustrated by dashed line 102. If the chirp rate is linear, at any given time there is a constant frequency difference between what the laser is currently producing and the frequency of the return signal. This frequency difference, referred to as the intermodulation (IF) frequency f_{IF}, is therefore given by the expression f_{IF}=(df/dt)·τ. As shown in FIG. 1, when τ increases then f_{IF} also increases and vice versa. Since τ=2R/c it is then clear that the IF frequency is proportional to the target range through the relationship f_{IF}=2·(df/dt)/c·R. Determining the IF frequency therefore permits a determination of the range.

One important point is that the IF frequency range over which targets will produce signals can easily be altered by altering the frequency chirp characteristics. This is important in order to keep the IF frequencies within a range compatible with the acceptable data rates and signal processing. For a given (df/dt) the total frequency difference Δfₘ=fₘₐₓ−fₘᵢₙ determines the maximum unambiguous range, while the fractional resolution in the frequency domain determines the achievable range resolution. If there are no constraints on the amount of chirp that can be produced, and the range of frequencies that can be detected and processed, the range resolution can be very high while at the same time permitting a very high unambiguous range. In reality infinite amounts of chirp cannot be produced and frequencies cannot be determined with arbitrary precision over an arbitrarily large bandwidth, thus forcing a compromise between range resolution and acceptable ambiguity. However, by using multiple frequencies to eliminate range ambiguities, it is clearly possible to create sequences of chirps at different chirp rates to eliminate range ambiguities. For example, it may be desired to first operate with a low chirp rate to first measure coarsely the target range with a very large unambiguous range, and then switch to a faster chirp rate to perform range measurements with substantially higher range resolution.

In FIG. 1 the chirp is illustrated as a single ramp in time. In real applications the chirp waveform would frequently be periodic such that when the laser reaches fₘₐₓ it resets to fₘᵢₙ and starts a new ramp. This ‘flyback’ does not normally take place instantaneously, but in many cases it may be fast enough that it does not affect operation. In cases where it is not sufficiently fast it is clearly possible to not process signals during this time—usually referred to as ‘blanking’. From the figure it is also clear that there will be a period when the laser has started a new ramp and light is still returning to the sensor causing a condition where the IF frequency has a different value f_{IF}′=f_{IF}−Δf, where Δf=fₘₐₓ−fₘᵢₙ. This condition can be handled in several ways. For many applications the ramp time T is often long (such as 1 ms or longer) compared to the target delay time τ. Therefore the fraction of energy in the frequency component at f_{IF}′ will be very small compared to the energy in the primary frequency signal component at f_{IF}. Second, the higher frequency signal f_{IF}′ is generally washed out by the finite receiver electronics bandwidth, which further attenuates this frequency component. For applications where τ is significant compared to the ramp-period, several solutions are possible as will be discussed below.

As an example of this measurement technique, if the laser ramp time is 1 ms and a 150 MHz ramp is produced during this time the chirp rate is 150 GHz/s and f_{IF}=1·10³·R. Thus every 1 m change in range produces a 3 kHz change in detected signal frequency. The maximum unambiguous range is where the IF frequency equals 150 MHz, or 150 km. If the sensor has a high tuning capability, a wide receiver bandwidth, and high resolution processing, it is therefore possible to achieve high range resolution over a large range. A drawback with this example is that the bandwidth requirement is very high, defeating a purpose of the invention of providing for low enough processing bandwidth requirements to be compatible with existing cameras and processors.

However, if the chirp rate is reduced to 100 MHz/s the maximum range is reduced to 100 m and over a 1 ms ramp time the maximum IF frequency is reduced to 100 kHz. This meets the requirements on significantly reduced processor bandwidth. Having a frequency resolution of 100 Hz within the 100 kHz wide unambiguous frequency window would then permit 10 cm resolution measurements over a range depth of 100 m. If the ramp is slowed down to produce a 100 kHz ramp at a 10 Hz rate the unambiguous range becomes 10 km. Thus, by for example operating the system first with the 10 Hz ramp the processor can perform a coarse range measurement to determine which 10 m range window the signal falls within. The ramp can then be switched to 1 ms and high resolution measurements carried out within a 100 m window centered at the previously determined coarse range. This technique would completely eliminate range ambiguities.

From the above discussion it is evident that for a given available electronic bandwidth and a given number of pixels, see below, there is a tradeoff between range resolution and range depth. By simply changing chirp and processing parameters the technique can be used to produce a variable resolution range sensor.

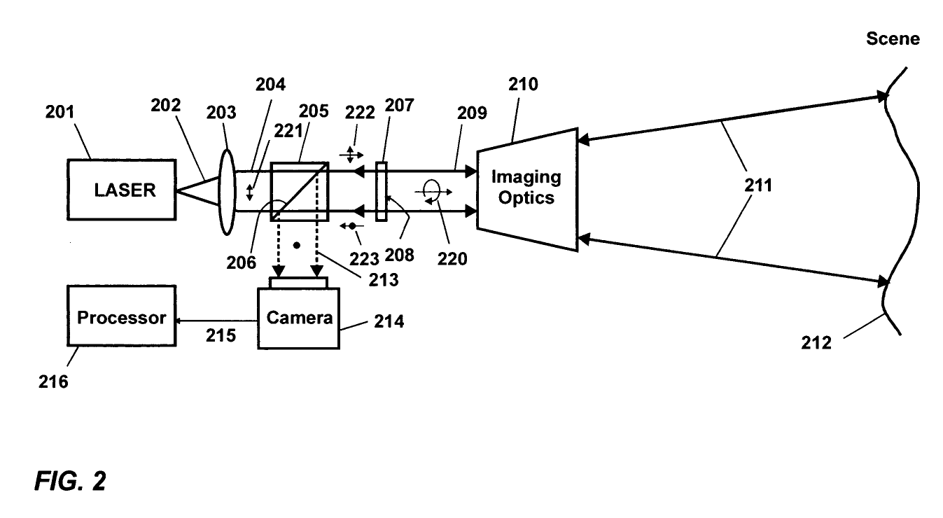

FIG. 2 shows a laser 201 produces a frequency chirped laser beam 202 that is used in conjunction with optics 203 to produce a collimated laser beam 204 that has little transverse variation in its size and has correspondingly flat wavefronts. Such a beam may be produced directly by the laser or it may correspond to for example the collimated output from a semiconductor diode laser. The latter frequently have a very small emission aperture with a correspondingly highly divergent beam. By placing a lens in the diverging beam a suitable collimated beam can be produced. The transverse dimension of the laser beam 204 is selected such that it approximately matches the transverse extent of the detector array that is used. This array may be for example 5×5 mm in size in which case the laser beam diameter would be chosen to be somewhat greater than 5 mm in each transverse dimension. It is contemplated that optical elements, such as telescoping optics, can be used to produce a laser beam of the appropriate transverse extent if there is a mismatch. To maximize efficiency of the system it is preferred that laser beam 204 is linearly polarized, for example in the plane of the paper, as indicated by symbol 221. Collimated laser beam 204 next propagates through polarizing beam splitter 205 which is constructed using conventional techniques to pass essentially all of the linearly polarized light as further indicated by symbol 222. The laser beam next traverses quarter-wave plate (QWP) 207 that converts the linearly polarized beam into a circularly polarized beam 209, as indicated by symbol 220. The right hand surface 208 of QWP 207 is partially reflecting such that it causes a small fraction, for example in the range of 1-10%, of the laser power to re-traverse QWP 207. Such a reflection may be caused by leaving surface 208 of QWP 207 uncoated, or surface 208 may be provided with a partially reflective coating as is common practice in optical systems. The re-traversal of the reflected beam back through QWP 207 causes the beam to become linearly polarized at 90 degrees to the original polarization, as indicated by symbol 223. Upon re-traversing polarizing beam splitter 205 the beam is consequently reflected off surface 206 and is redirected along dashed path 213 towards camera 214. This beam is referred to as the local oscillator (LO) beam.

Laser beam 209 that is not reflected at surface 208 propagates towards an imaging optics subsystem 210 that may comprise a simple lens or a more complex set of optics. Following traversal through imaging optics 210 the laser beam propagates along paths 211 to illuminate a scene 212 that one desires to image. A useful and convenient feature of the invention is that imaging optics 210 can have zoom capability to permit the field of view of the camera to be varied either manually or through e.g. computer control as the need arises.

A fraction of the light scattered from scene 212 propagates back along directions 211, re-traverses imaging optics 210, and passes through QWP 207. A small portion of this light will reflect from coating 208 and is lost, but most of the light will propagate through QWP 207. Scattering objects at scene 212 will frequently not depolarize the incident light such that the non-depolarized portion of the scattered light will return through QWP with a linearly polarized state as indicated by symbol 223. This light will then also reflect from surface 206 and be redirected to camera 214. This reflected light will consequently mix coherently with the local oscillator beam at the camera and a heterodyne beat signal is produced whenever the frequencies of the local oscillator light and the light scattered from scene 212 differ. It is now also clear that the primary purpose of imaging optics 210 is to image scene 212 onto camera 214. If this is done there is a one-to-one correspondence between scattering points at scene 212 and image points at camera 214. Electrical signals from camera 214 are then passed along lines 215 to a processor 216 for determination of beat frequencies between the local oscillator beam and spatially resolved points on the camera detection surface. A number of variations of the disclosed embodiment can be made to work satisfactorily.

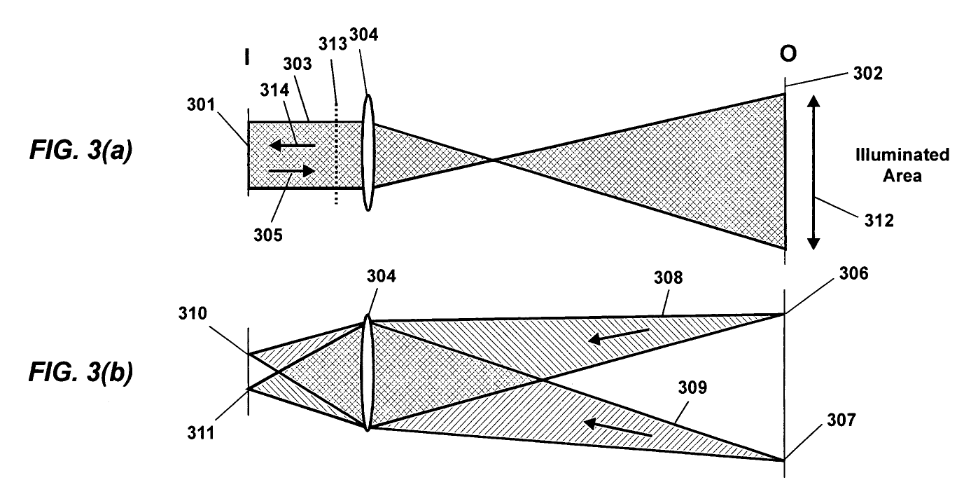

In order for coherent mixing of two light fields to be efficient it is required that two conditions are met, in addition to requiring that the field have the same polarization. First the two light fields must overlap spatially. Second, the wavefronts of the two beams must be aligned. The first condition is frequently simple to satisfy, whereas the second condition often imposes more stringent design constraints. In many cases it is easiest to discuss in terms of planar wavefronts. Non-planar (for example spherical) wavefronts will also mix efficiently and may be incorporated without loss of generality. In the example described with reference to FIG. 2 the local oscillator produces planar wavefronts at the camera (image) plane. In order to obtain high efficiency it is then necessary to ensure that light returning from scene (object plane) 212 also has planar wavefronts co-aligned with the local oscillator wavefronts. With reference to the present case illustrated in FIG. 3 how this is accomplished. For clarity the transmission path is shown in FIG. 3a) and the reception path is shown in FIG. 3b).

In FIG. 3a) is shown an object plane (“O”) 302 and an image plane (“I”) 301. Illuminating laser beam 303, corresponding to beam 209 in FIG. 2, propagates in direction 305 through imaging system 304, here illustrated as a simple lens. The imaging system 304 causes the light beam to illuminate an area of extent indicated by arrow 312 at object plane 302. Light is scattered (e.g., reflected, refracted, and/or diffracted) from objects at object plane 302. When the object is diffuse each point acts as a point scatterer and light from such points, exemplified by points 306 and 307, is scattered as indicated by 308 and 309. Because of the imaging action of imaging system 304, each point at the object plane produces a luminous point at a corresponding location at image plane 301. Thus, object point 306 produces image point 311 and object point 307 produces image point 310. If imaging system 304 has good fidelity the wavefronts at image points 310 and 311 are substantially flat and they will consequently coherently mix with a local oscillator beam also having a flat wavefront. In FIG. 2, a flat local oscillator wavefront was shown to be generated by reflecting a small portion of transmitted beam from surface 208. This corresponds to insertion of surface 313 in FIG. 3, which generates a local oscillator beam 314. The coherent mixing as described meets the criteria noted above of spatially overlapping two beams with matching wavefronts and equal polarizations. As a result the two beams will produce a beat signal when their frequencies differ.

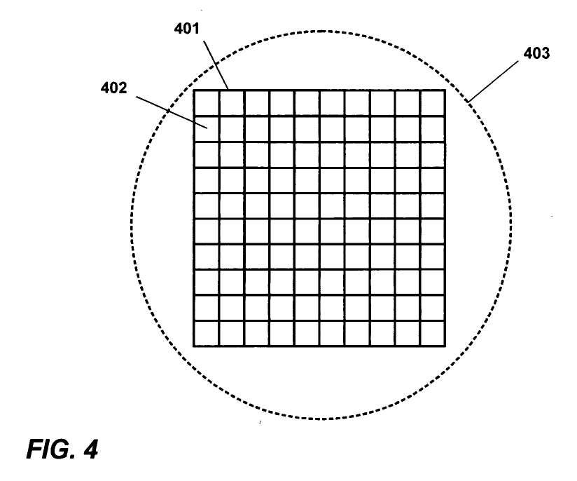

In FIG. 4 is shown an array of detectors 401, illustrated as having a square array of 10×10=100 individual detector elements (“pixels”) 402. The number of pixels available is determined by the camera manufacturer and is only illustrated to equal 100 for clarity. Digital camera technology is advancing rapidly and it is common for pixel counts to exceed 1 million today. The extent of the local oscillator beam is illustrated by dashed circle 403. Generally the local oscillator beam would be shaped such that it fills the entire detector array 401. If it under fills the array some elements are not illuminated with local oscillator light and hence provide no heterodyne signal. If it is significantly overfilled light is wasted. It is frequently desirable that each pixel is illuminated with approximately equal local oscillator power. Laser beams commonly have a Gaussian distribution of power across the beam such that the intensity is highest in the center and falls off with increasing radius from the center. Local oscillator power variations can be minimized by somewhat overfilling the detector 401 such that the central portion of the laser beam fills the entire detector area 401. Alternatively the local oscillator beam may be shaped to produce, for example, a top-hat or super-Gaussian illumination profile with locally flat wavefronts (flat over the area of a detector pixel) at the detector surface.

As shown in FIGS. 2 and 3, an image of the object is formed on detector array 401 such that each array pixel corresponds to a point or small area at the object. Since each array element 402 is mixed with a small part of the total local oscillator beam 403, each pixel can be processed individually. Since the beat signal from each detector element contains information about range to the corresponding object point, a range image can be formed. It is also clear to those skilled in the art that in addition to retrieving the heterodyne beat frequency, the signal processor can also retrieve the strength of the signal, corresponding to the intensity of the scattered light. In addition to forming range images one can then easily form intensity images that may be useful in providing further information about a target.

Two developments are useful to implementations of the range imaging system of the present invention. The first is the development of low-cost imaging detector arrays (cameras) with low electrical noise. Low noise is essential in building the system as noted because efficient coherent (heterodyne) detection requires sufficient local oscillator power to be present to ideally produce shot-noise limited detection sensitivity. Shot noise represents fluctuations in the detector current that are induced by fluctuations in the local oscillator power. With currently available cameras the shot-noise limit may be reached with 10-100 μW or less of local oscillator power per pixel. If the camera has 1000 pixels the total amount of local oscillator power is then in the range of 10-100 mW. In a case where electrical noise forces the local oscillator power up by several orders of magnitude, the power may become so high that it becomes difficult to produce, it saturates the detector array, or it damages the camera through heating.

The second enabling element is the notion that range measurements can be done with low detector bandwidths. As noted in the background section, conventional detection techniques require very high bandwidths, for example in the range of 10-1000 MHz. Sampling such a signal at the so-called Nyquist criterion of 2×bandwidth would produce digitized data at rates of 20 million samples per second (20 Ms/s) to 2 Gs/s. If each pixel produces continuous data at such rates a 1000 pixel camera would consequently produce total data rates of 20 Gs/s to 2 Ts/s, which becomes extraordinarily difficult to route and process in real time. However, by using the FMCW approach noted it is possible to effect an enormous reduction in data rates. For example, if the laser is repetitively chirped at a rate of 1 GHz/s then a target at a range of 1500 meters produces a beat signal at a frequency equal to f_{IF}=(1 GHz/s)(2)·(1500 m)/(3·10⁸ m/s)=10 kHz. Digitizing this at 20 ks/s and multiplying by 1000 pixels then produces a total data rate of 20 Ms/s, 3-5 orders of magnitude less than the previous example. Such data rates are within reach of currently available camera technology. As an example, the model SU320MSW-1.7RT InGaAs camera from Sensors Unlimited can currently produce data rates of 10 Ms/s with future versions anticipated to be capable of at least 100 Ms/s. Further development of these and other cameras is likely to substantially increase the pixel counts and/or data throughput over time. Such devices can clearly be incorporated into the invention with resulting improvements in pixel counts and/or per pixel bandwidth. Using a 100 Ms/s device with 1000 pixels would make it possible to process signals with a bandwidth up to 100 kHz each. Such cameras can also often be programmed to output data from a predetermined selection of pixels, with the total data rate typically being the bottleneck that currently limits how many pixels can be processed for a given rate per pixel. If the total data rate is limited to 100 Ms/s it is therefore possible to output data from a large number of pixels, for example 10,000 as long as each pixel is limited to output at a rate of 10 ks/s. Conversely the same device may be programmed to output data from 100 pixels at a 1 Ms/s rate from each pixel. The appropriate partitioning of number of pixels versus per pixel data rate is determined by the specific application at hand.

With freedom to select which pixels to process it is clearly possible to configure the optical system and the camera to process for example a line image rather than a two-dimensional image. One can for example process a 100 pixel wide image at relatively high speeds per pixel. This can produce two-dimensional imagery through so-called push broom and whiskbroom techniques where the second dimension is obtained by sweeping the array in one angle. This can be particularly useful when the platform is moving and the image along the track of movement is formed by the platform motion. At the same time it is apparent that pixel selection is not limited to selecting lines. In general any combination of pixels or groups of pixels can be selected for processing to meet desired measurement capability.

1. Transmitter Lasers

The invention is not dependent upon use of any particular transmitter laser as long as it meets four requirements: its wavelength is matched to the spectral sensitivity range of the detector used; it produces the appropriate linear chirp waveform; it has a sufficiently high frequency stability to be useful over the measurement range of interest; and that it has enough power to produce sufficient signal power at the detector locations.

If InGaAs detector elements are used it may be advantageous to operate the camera system in the wavelength range of 1-2 micrometers. Laser sources in the approximately 1530-1620 nm range have some advantages here in that they present a reduced eye-hazard compared with common 1000-1100 nm lasers and that many component technologies are readily available that were developed for optical telecommunications systems. For example, it may be useful to incorporate frequency shifting devices or laser amplifiers into the system. Such components can be purchased from a number of vendors in the common telecommunications C and L bands that cover approximately 1530-1620 nm range. Cameras operating in the visible spectral range below 1000 nm, or infrared sensitive cameras operating at wavelengths greater than 2000 nm, can also be used provided that the transmitter laser is selected to output a wavelength in the appropriate range.

The second noted requirement on the laser is that it produces a frequency chirp with a high degree of linearity. Non-linearity in the chirp broadens the measured frequency spectral peak and sufficient non-linearity may make the measurement difficult or impossible. As noted the measured frequency shift is given by f_{IF}=(df/dt)·2R/c under the assumption that the chirp rate df/dt is constant over the time τ of the chirp. If df/dt varies with time an error is introduced in f_{IF}. For example, if df/dt varies by a fractional error δ over the time τ then generally speaking this introduces a fractional error of δ in the frequency measurement and hence in the range measurement. To determine range with a certainty of 1% the chirp rate should be linear to within on the order of 1%. This is not an exact relationship because a nonlinear chirp tends to broaden a detected frequency peak, thereby reducing the peak signal-to-noise ratio (SNR), rather than shift the peak. As a result the range measurement penalty is associated with accurately locating the center of the peak, a common issue in Doppler frequency measurements. Under high SNR conditions or in cases where the shape of the non-linearity is known there may not be any significant penalty associated with non-linear chirps. Even highly nonlinear chirps may be acceptable, but since they generally increase the load on the signal processor this is undesired. The semiconductor diode laser can be chirped as described above, or, alternatively using techniques discussed in U.S. Pat. No. 4,666,295 to Duvall et al., U.S. Pat. No. 4,662,741 to Duvall et al., and U.S. Pat. No. 5,289,252 to Nourrcier, hereby incorporated by reference.

The third requirement is that the transmitter laser produce a sufficiently narrow spectral line. Unintentional variations of the transmitter laser frequency during the time of flight to and from the target spectrally broaden the detected heterodyne beat signal that generally degrades range measurement accuracy. To maximize the system detection efficiency and range accuracy, it is desired that the laser should produce frequency fluctuations that are small compared with the detection bandwidth. For example, if the receiver bandwidth is 100 kHz and it is desired to measure range to 1 part in 100, the laser should have a frequency bandwidth <100 kHz, and ideally <1 kHz. Without special controls many lasers produce frequency line widths far in excess of these numbers and are not useful. However, what is important is not the line width of a source measured over a long time period, but only the line width with a delay corresponding to the maximum range of interest. For example, a system intended for a maximum range of 10 km has a delay time of 67 microseconds. Therefore a laser that has a frequency stability of better than 1 kHz over a 67 microsecond time interval may be well suited. Such lasers are commonly used in conventional coherent laser radar systems. It is also clear from this discussion that the frequency stability requirements are reduced as the maximum target range is reduced. If the target range is very short, for example 1 m, then the round-trip time of flight is only 6 ns. Thus the laser only has to demonstrate high frequency stability over a 6 ns time interval, which is a far easier condition to meet with off-the-shelf laser sources.

The fourth requirement concerns laser power, which is dependent upon a number of factors, including: the number of pixels, attenuation in the atmosphere, target reflectivity characteristics, maximum target range, and signal processor characteristics. Few general statements can be made except to note that commonly available diode lasers, for example, may by themselves not be ideally suited for the disclosed systems. In addition to noted issues with excessive line widths, typical devices currently only produce power levels of tens of mW. Spreading such small power over a large number of target points will produce very low receiver power, in many cases below reasonable detection levels. For example, if there are 1000 target points and power level of several mW per pixel is desired, the required transmitter power increases to several watts. Such power is available from many solid-state lasers, but can also be obtained from diode lasers provided that these are followed by one or more laser amplifier stages. For operation in appropriate wavelength bands, such as the two common C and L telecommunication bands that cover approximately 1530-1620 nm, fiber amplifiers are particularly suitable to provide such output powers.

2. Signal Processing

The imaging sensor described produces data at a substantial rate. A number of possibilities exist for reading out data from the camera and processing the data flow. Because each pixel produces a beat frequency signal the signal processor needs to determine the beat frequency and output the result to a suitable user interface. Several methods exist to determine beat frequencies and the invention is not dependent on which one is chosen. For example, a fully digital system may digitize the data stream on a pixel-by-pixel basis and calculate the Fourier transform of the time series. The square magnitude of the Fourier transform constitutes a frequency power spectrum. By determining the dominant spectral peak and using known chirp rates the range for each pixel can be calculated and output to the user interface. The most computationally intensive part of the calculations is computing the Fourier transform, but existing fast Fourier transform (FFT) processing chips can compute approximately 125,000 FFTs per second, each one with 1024 points. An example of use of such an FFT processor would be to capture 1024 samples per pixel at a sampling rate of 10 kHz. The data collection time would then be 100 ms for each pixel corresponding to 10 waveforms per second, the processor could then handle 12,500 pixels per second, which is sufficient for many applications. For faster data rates faster computers or multi-processor computers or computers with dedicated FFT hardware can be employed. Ultimately the FFT algorithm can be implemented directly in the camera itself. An alternative method to process data would be to use, for example, surface acoustic wave (SAW) devices. As with camera technology, signal processing technology is also rapidly improving, for example in the number of FFTs that can be processed in a given amount of time. Such future improvements in hardware, software, and algorithms, can clearly be incorporated into the invention in order to process more pixels per unit time, or to otherwise improve the measurement capability.

When the target is distributed along the lines of sight, or multiple targets are distributed along a line of sight, such as may the case when an illuminating beam first reflects from a tree canopy and then reflects from an object behind the tree canopy, the received signal at the detector will comprise multiple components. Each feature appearing within the search interval along a line of sight may scatter energy toward the detector. The detector superimposes these multiple components such that the detector output comprises plural beat frequencies when the components are sinusoidal signals. Each component corresponds to a range to a particular target or feature in the line of sight corresponding to that component. The resulting multiple frequencies are retrieved by, for example, spectral analysis of the detector output signal and hence multiple targets along each line of sight may be detected and ranged.

3. Alternative Embodiments

A number of alternative embodiments of the invention are possible as is apparent to those skilled in the art. Such alternative embodiments may be desired to meet specific requirements, including maximizing heterodyne mixing efficiency, optimal use of laser power, or flexibility in making range imaging measurements.

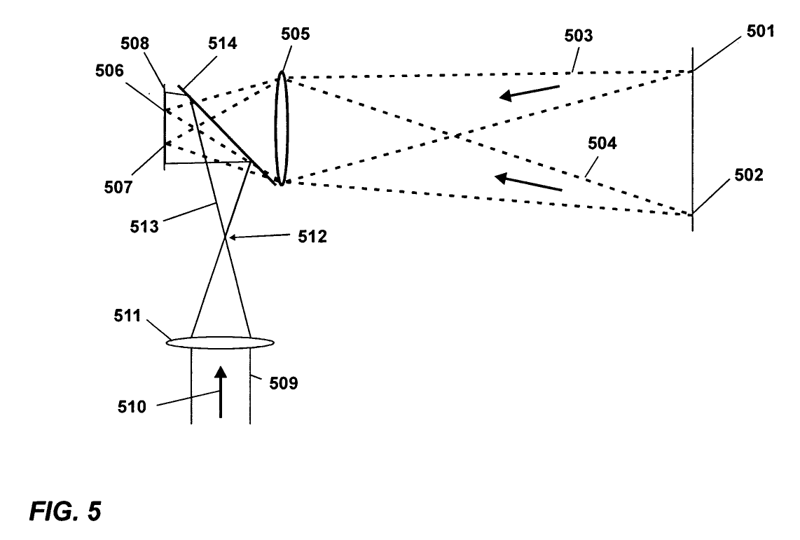

As noted above matching the wavefronts of the local oscillator beams to the wavefronts of the points of the image at the detector array plane is critical in order to maximize the system efficiency. What is important is that the wavefronts are matched over the size of each detector pixel. The embodiment illustrated in FIGS. 2 and 3 has some limitations, particularly if the field of view is large. Image points 310 and 311 may have flat wavefronts over pixel dimensions but for pixel locations that are significantly off axis with respect to optical axis of the imaging system, they may be tilted with respect to the local oscillator wavefronts. In general such tilt increases quadratically with pixel distance from the optic axis. This potential problem may be remedied through the use of optical elements to flatten the phase fronts, but in the absence of such elements it suggests that a better match would be to ensure that the local oscillator beam should be configured to have a spherical wavefront as well. One way of arranging this is illustrated in FIG. 5. In FIG. 5 two object points 501 and 502 produce scattered light 503 and 504 that propagates back towards the sensor location and are imaged using imaging system 505 to produce image points 506 and 507 at image plane 508 where the detector array is placed. To produce a matched local oscillator, beam 509 is incident on lens 511 along direction 510. This produces a focus at a point 512. Beyond the focal plane 512 the beam 513 continues to propagate as an expanding spherical wave. A beam splitter 514 is placed at a location as shown such that a fraction of beam 513 is redirected to illuminate image plane 508 with a spherical wave. Beam splitter 514 also reflects some of the incident light from the object plane and therefore represents an efficiency loss in the system. For this reason it is advantageous for beam splitter 514 to reflect a small fraction, for example 10% of the light incident upon it, and transmit 90% of incident light. Several variations of this implementation are possible, for example using mirrors with small holes or beam splitters that have a small reflective dot appropriately positioned to only reflect a small local oscillator beam. In these cases is may be advantageous to arrange the local oscillator beam focus near the location of beam splitter 514 to ensure that the hole or obscuration is small in relation to the transverse dimension of the received signal beam. Such approaches to matching local oscillator beams with received signals have been discussed by Paranto and Cates in “Coherent Heterodyne Array Mixing for Laser Radar”, presented at 12^{th} Coherent Laser Radar Conference, Bar Harbor, Me. June 2003, hereby incorporated by reference.

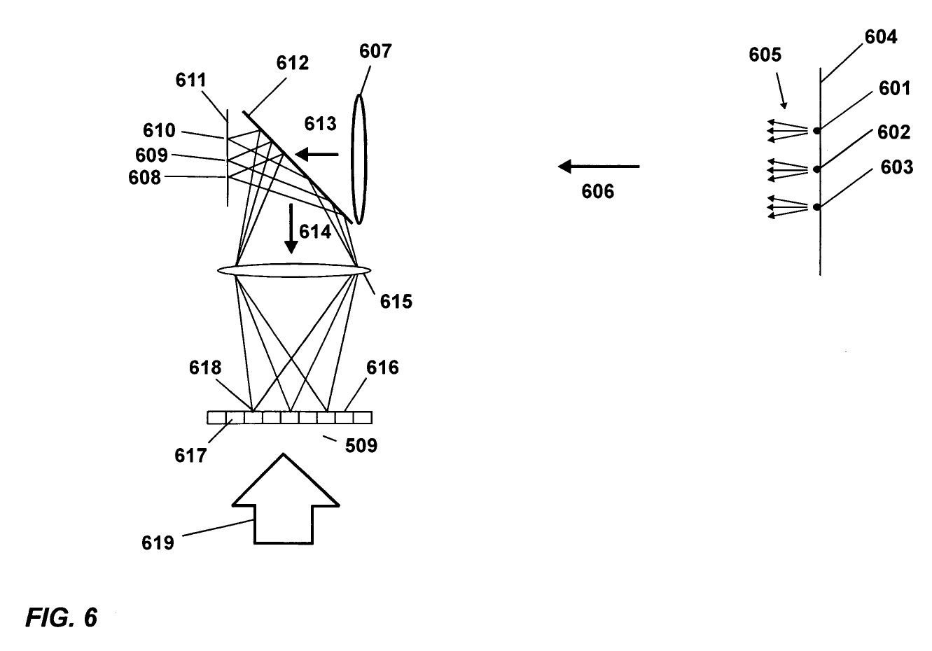

A further improvement on matching wavefronts at all pixel locations is illustrated in FIG. 6. To understand this Figure it is noted that the best possible matching of wavefronts can be obtained using the so-called back-propagated local oscillator (BPLO) method. This method is frequently used with single-pixel coherent laser radar systems. The method states that one can generate an optimally matched LO beam by starting with the field corresponding to an image point and propagate that field back through the system. If a local oscillator field is generated that matches that back propagated field then an optimal match is found. This principle can be applied to the imaging array under discussion, as follows. FIG. 6 illustrates again an object plane 604 that scatters light from multiple points 601-603. Each of these points gives rise to light 605 that propagates towards the sensor along the general direction 606, enters imaging system 607, and follows general direction 613 to form a corresponding set of image points 608-610 at image plane 611. If the imaging system is well constructed each pixel location at image plane 611 can be treated as a small aperture upon which light converges from imaging system 607. As a result each pixel “sees” a converging spherical wave incident from a mean direction that depends on the distance of the pixel from the optic axis of the system. A well matched local oscillator field is created by back propagating independent fields from each pixel location. By inserting a beam splitter 612 in the path of these fields the fields can be redirected along a direction 614. By placing an optical system 615, such as a lens, in the path of these back propagated fields, image plane 611 is re-imaged onto a secondary image plane 616 with a desired magnification. There is then a one-to-one correspondence between points at the two image planes, for example point 608 images to point 618.

At image place 616 is now placed a suitable device such that if the device is illuminated with a laser beam 619 the device causes fields to propagate in the forward direction through imaging system 615, reflect from beam splitter 612, and form a set of image points at each detector pixel in image plane 611. A number of different devices can be used at image plane 616. One possibility is to divide the area into a number of segments 617, the number being substantially equal to the number of detector pixels at image plane 611. Each such segment is then caused to emit a spherical wave. This can be done by making the device a phase screen, such that each segment 617 in the screen causes a phase shift to be imposed on the part of beam 619 traversing that segment, such phase shift being substantially different from the phase shift imposed on parts of beam 619 that traverse adjacent segments of the screen. A device of this form has been disclosed in U.S. Pat. No. 5,610,705 to Brosnan in the context of a laser Doppler velocimeter, hereby incorporated by reference.

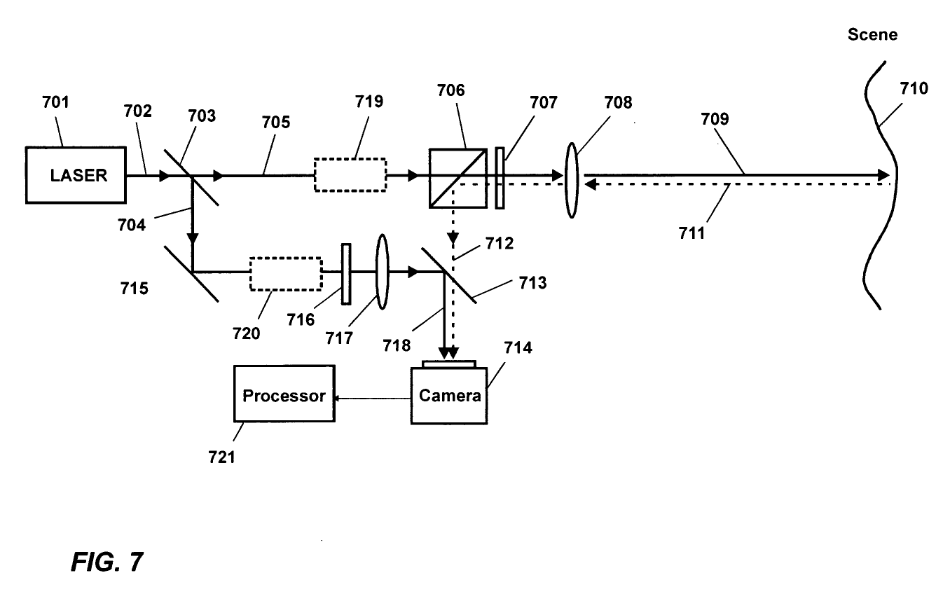

A configuration as shown in FIG. 6 cannot easily be incorporated into the sensor architecture as illustrated in FIG. 2, but can be incorporated for example as shown in FIG. 7. In FIG. 7, a laser 701 produces a linearly polarized laser beam 702 that is incident on a beam splitter 703 to create one local oscillator beam 704 and one transmission beam 705 with a predetermined ratio of power in each beam. Transmit beam 705 passes through a polarizing beam splitter 706, through quarter-wave plate 707, through imaging optics 708 and proceeds along direction 709 to illuminate the scene of interest 710. Scattered light returns along path 711 through imaging optics 708 and through quarter-wave plate 707. Since the return light is now polarized orthogonally to the transmit beam it is reflected from polarizing beam splitter 706 and directed along path 712 through beam splitter 713 and onto camera 714. As noted above beam splitter 713 is designed to pass for example 95% of the light and reflect 5% of the light incident upon it. At the same time local oscillator beam 704 is directed using appropriate optics 715 to diffracting element 716 and imaging optics 717, as discussed in conjunction with FIGS. 5 and 6, to produce a set of matched local oscillator beams (“beamlets”) that reflect from beam splitter 713 and impinge on camera 714 in such a manner that each beamlet 718 is matched spatially and in wavefront to a scene element image of dimension substantially equal to one detector pixel. As in FIG. 2 camera output is directed to a signal processor 721 for extraction of target range information.

Two additional elements are illustrated in FIG. 7 that may be useful in improving the sensor performance. Element 719 illustrates a point where an appropriate laser power amplifier may be inserted to increase the laser power illuminating the scene. If needed to provide sufficient local oscillator power element 720 could also be an amplifier to boost power.

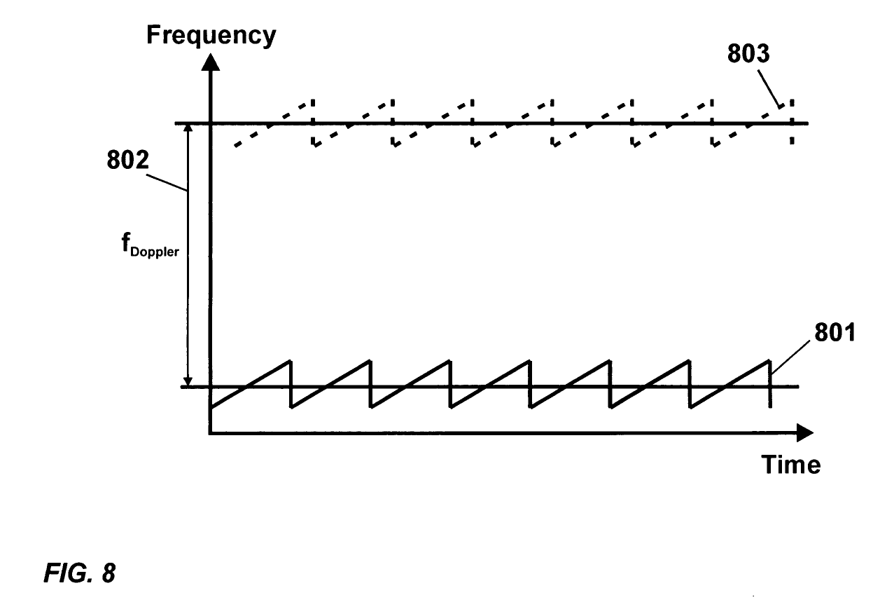

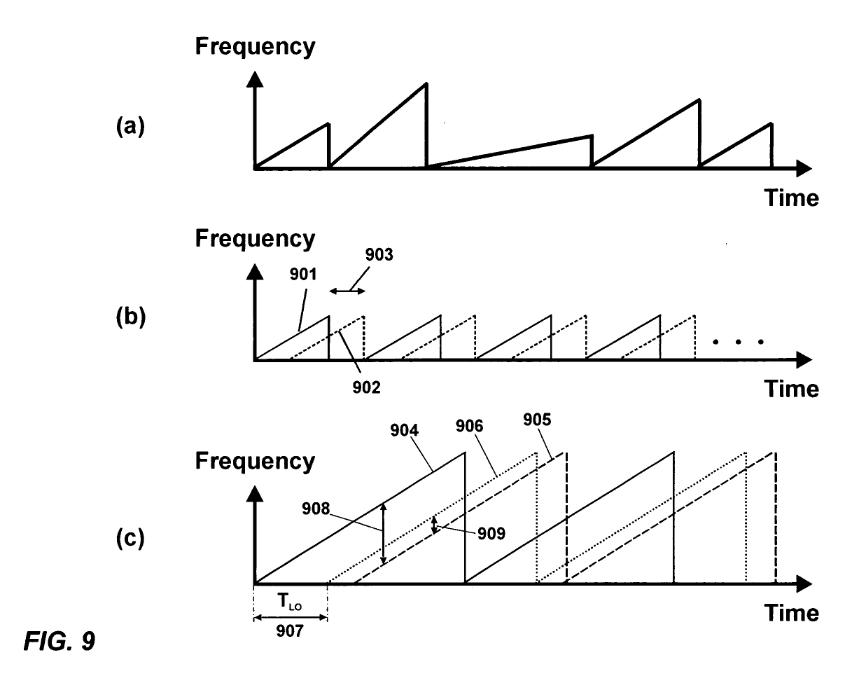

An element inserted at this (or a similarly chosen location) could also serve an additional purpose that can be seen with reference to FIG. 8. As noted, a primary advantage of the present invention is that the receiver does not need to have a very large bandwidth. A consequent disadvantage is that the sensor cannot tolerate a great deal of motion between the sensor and target. Such motion at a speed v produces a Doppler frequency shift f_{Doppler}=2v/λ, where λ is the laser wavelength. For λ=1500 nm each 1 m/s of motion shifts the scattered return light by approximately 1.3 MHz. If the laser produces a chirped waveform as illustrated by 801 in FIG. 8, the return waveform will be shifted vertically as illustrated by 803 through the imposition of a constant Doppler frequency shift of magnitude 802. It is clear that using the disclosed sensor on a rapidly moving platform may shift the received signal waveform 803 by a sufficiently large amount that the heterodyned signal frequency is outside the bandwidth of the receiver. To circumvent this problem means have to be implemented to reduce the vertical spacing between waveforms 801 and 803. The manner in which such reduction is accomplished is not important. It can be achieved by shifting the received signal to a lower frequency or it can be achieved by shifting the local oscillator to a higher frequency, or a combination of the two. A relatively simple way of achieving such a shift is to insert a frequency shifting device into the local oscillator path at location 720 in FIG. 7. This device could comprise for example a phase modulator that generates a sideband at the Doppler frequency, in combination with a tunable filter that only transmits an appropriately chosen sideband. Phase modulators can generate widely tunable sideband frequencies over many GHz by driving them with a radio-frequency signal at the desired frequency. This provides a means to dynamically “tune out” any Doppler shift experienced or known. Another way is to add a constant offset frequency to the LO, using a tunable LO. The offset frequency is computed using knowledge of the sensor velocity relative to the target, as for example provided by separate Doppler sensors or aircraft navigation systems. In cases where the Doppler shift is not known it may be found by, for example, using a tunable frequency shifter in conjunction with search algorithms that scan the offset frequency until a signal is found, meaning that the frequency shift at that point is appropriate for nulling the Doppler shift. Nevertheless, because of the ambiguity between Doppler frequency and range, this approach, which ensures the signal is within the electronics bandwidth, does not resolve this ambiguity. One approach to resolving the ambiguity is to transmit multiple ramps with sufficiently different frequency chirp rates (df/dt). With two or more sufficiently different chirp rates the ambiguity can be resolved.

To conserve both receive and local oscillator power a dual-port receiver requiring an additional camera can be placed at the unused port of the mixing beam splitter. In this manner, a beam splitter with a power ratio of 50/50 rather than 10/90 is used. Because the heterodyne signal in the two beam splitter ports are known to be approximately 180 degrees out of phase, the signals from the two cameras are subtracted to produce a single signal with improved signal-to-noise ratio and requiring less local oscillator laser power.

4. Alternative Waveforms

The invention has largely been discussed in terms of implementing simple frequency ramped waveforms that are repeated temporally. While this works well in many measurement situations, there are many other cases where alternative waveforms are better suited.

In addition to altering the chirp rate as noted above, it is also apparent that the ramp time can be altered to suit specific measurement scenarios. Since a full system according to the present invention provides complete control over chirp rates, ramp times, and the like. It is also not a requirement that the same chirp be repeated over and over again. Rather, the chirp parameters may be altered as desired on subsequent ramps to provide maximum flexibility in performing measurements.

Examples of alternative waveforms are illustrated in FIG. 9. FIG. 9 (a) shows a series of chirped waveforms where the chirp rate and ramp time are varied from one ramp to the next. This is useful, for example, in scanning a wide range of target locations with variable range resolutions or to produce received signals that eliminate range-Doppler ambiguities as discussed above.

FIG. 9 (b) shows transmitted 901 an scattered 902 waveforms where the transmitter is blanked out for a time period shown as 903. This is useful, for example, in ensuring that no signal ambiguity exists during a time period where the transmitter frequency has been reset to its minimum value while signals are still being received from the target.

FIG. 9 (c) shows yet an alternative waveform, where the transmitted 904 and scattered 905 waveforms are complemented with a local oscillator waveform 906 delayed from the transmitted waveform 904 by a time T_{LO} as shown by arrow 907. This form is useful in order to, for example, reduce the IF frequency from a large value 908 to a smaller value 909. Such a delayed local oscillator waveform may be produced by several means. One way is to use time delay a sample of the transmitter waveform in an optical fiber, which could be of fixed length for a fixed time delay or could have multiple taps for different delays. A second way to generate this delayed LO is to use a separate local oscillator laser. A third way would be to frequency shift a sample of the transmitted laser beam with a frequency shift corresponding to a desired time delay.

It should be understood that the illustrated waveforms serve as exemplary forms only and that other useful waveforms will be apparent to those skilled in the art.

5. Speckle Fading Mitigation

The invention is useful for any type of target, whether they produce specular reflections or scattering from distributed targets (multiple targets at different ranges including distributions of discrete small particles, such as aerosols, in the atmosphere). In the case of distributed targets speckle are produced when coherent detection is utilized. Speckle effects are caused by interference of light scattered from randomly distributed targets and result in fluctuations in the received signal amplitudes. In many cases speckle effects are not critically important, but in cases where these effects are important, it is notable that multiple methods exist to mitigate any detrimental impact on the measurements. In general, at least one parameter of a system should change in order to mitigate speckle effects. This is so because a measurement situation in which both the source and target are stationary will produce the same speckle statistics every time. By altering the measurement to ensure that interferometric phase relationships between target scatterers and the receiver are changed, one can perform sampling of the speckle statistics, thereby allowing incoherent averaging over the statistical distributions.

Multiple methods exist to induce a sufficient change in at least one parameter to effect the desired change in speckle. One approach is to alter the polarization of the transmitted light, either within a ramp or on subsequent ramps. With a suitable polarization sensitive receiver (or two receivers/processors with separate processors) one can obtain two independent speckle realizations. A second method is to produce a sufficient frequency shift of the transmitter mean frequency between measurements times (for example on subsequent ramps). The approximate required frequency shift is c/4ΔR, where ΔR is the range resolution depth. For example a 1 cm target depth would require a shift of ˜7.5 GHz. A third method would be to implement multiple receivers (including local oscillators) that view the target from different angles.

The above techniques are generally applicable to all targets. In many realistic measurement scenarios the temporal speckle statistics are driven also by relative motion within the target, in which case one can define a target coherence time. For example, aerosol particles move relative to one another and hard-targets that translate or rotate also alter the phase relationship of scattering particles relative to the receiver. In these cases it is generally not useful to carry out individual coherent measurements over longer time periods than the target coherence time. From a measurement precision standpoint it is frequently more desirable to perform multiple separate measurements, each with a duration of approximately one target coherence time, and then average the results incoherently. Such processing can easily be done by breaking the return signal into segments of length t_{seg}, perform an FFT or other suitable processing on this segment, repeat this process for a number of segments, and then average the result. Since target coherence times vary widely, for example between 0.001 and 1 ms, it is often possible to divide each frequency ramp period into multiple time segments t_{seg}.

The flexibility and cost benefits of the present invention enable a number of applications in a variety of fields. These applications include, but are not limited to: terrain mapping, target identification based on three dimensional range or range/intensity imagery; target tracking; collision avoidance sensors for e.g. automotive, avionic, and industrial use; and mapping of shapes, such as buildings, construction sites, accident scenes, the human body, and the like. Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A three-dimensional range imaging device comprising:
an illuminating beam directed to illuminate a scene, wherein the illuminating beam has a waveform having a frequency chirp;
a local oscillator beam also having a frequency chirp;
mixing optics operable to output a mixed beam, wherein the mixed beam comprises scattered energy from the illuminated scene coherently mixed with the local oscillator beam;
a plurality of detector elements, wherein each detector element is optically coupled to the mixing optics to receive a portion of the mixed beam corresponding to a portion of the illuminated scene,
wherein each detector element generates an output signal comprising one or more sinusoidal components, and
wherein each of the sinusoidal components has a frequency corresponding to the range to a feature in the portion of the illuminated scene corresponding to that detector element, and
a signal processor coupled to receive the output signal from each of the plurality of detectors, wherein the signal processor determines a frequency of each sinusoidal component to determine a range to one or more features in the portion of the illuminated scene corresponding to that detector element.

2. The three dimensional range imaging device of claim 1 wherein the frequency chirps are substantially linear.

3. The three dimensional range imaging device of claim 1 wherein the frequency chirps are substantially linear with a chirp rate df/dt; and
the algorithm used by the signal processor determines the range R according to an equation of the form
$$R = c ( \frac{f}{2} ) / ( \frac{ⅆ f}{ⅆ t} )$$
where c is the speed of light and f is the determined beat frequency.

4. The three-dimensional range imaging device of claim 1 wherein the plurality of detector elements are provided in a detector array.

5. The three-dimensional range imaging device of claim 4 wherein the detector array comprises an InGaAs detector array.

6. The three-dimensional range imaging device of claim 4 wherein the detector array comprises a silicon detector array.

7. The three-dimensional range imaging device of claim 4 wherein the detector array comprises a charge coupled device (CCD) array.

8. The three dimensional range imaging device of claim 1 wherein the range resolution is adjustable.

9. The three dimensional imaging device of claim 8 wherein the range-resolution is adjusted simultaneously with a compensatory adjustment in a range search interval such that a substantially fixed number of resolution elements is maintained.

10. The three dimensional range imaging device of claim 9 wherein the range resolution is adjusted by varying the chirp rate.

11. The three dimensional range imaging device of claim 1 further comprising receiver optics, wherein the receiver optics images scattered light from the illuminated scene onto the plurality of detectors.

12. The three dimensional range imaging device of claim 1 wherein the illuminating beam is generated by a laser.

13. The three dimensional range imaging device of claim 1 wherein the illuminating beam is generated by a semiconductor diode laser.

14. The three dimensional range imaging device of claim 13 wherein the substantially linear frequency chirp is produced by altering the drive current to the semiconductor diode laser.

15. The three dimensional range imaging device of claim 1 wherein the signal processor implements an FFT algorithm.

16. The three dimensional range imaging device of claim 1 wherein the signal processor implements a surface acoustic wave (SAW) filter.

17. The three dimensional range imaging device of claim 1 wherein the frequency chirp is repeated temporally such that the chirp starts at a minimum frequency value and increases substantially linearly to a maximum frequency at said chirp rate (df/dt) and then returns to said minimum frequency value before being repeated.

18. The three dimensional range imaging device of claim 1 wherein said signal processor determines the intensity of scattered energy received from each feature in the portion of the illuminated scene corresponding to a particular detector element.

19. The three dimensional range imaging device of claim 1 further comprising a frequency shifting element to produce a relative frequency shift between the local oscillator and the scattered energy.

20. The three dimensional range imaging device of claim 20 wherein said frequency shifting element comprises an acousto-optic device.

21. The three dimensional range imaging device of claim 1 further comprising means to match the wavefronts of the local oscillator beam and the scattered energy at each detector element.

22. The three dimensional range imaging device of claim 1 wherein a parameter is changed during measurements to reduce speckle fading.

23. The three dimensional range imaging device of claim 22 wherein said parameter is one from the group of laser frequency, polarization, and look-angle.

24. The device of claim 1 further comprising:
splitting optics coupled to the illuminating beam and operable to split the illuminating beam into a transmission portion for illuminating the scene and a local oscillator portion forming the local oscillator beam.

25. A method for generating a three-dimensional image comprising:
illuminating a scene using an illuminating beam having a frequency chirp;
optically mixing scattered energy from the illuminated scene with a local oscillator beam to form a mixed beam;
detecting a plurality of component signals in the mixed beam, wherein each component signal corresponds to a spatially unique portion of the illuminated scene; and
determining a range R to each feature in the spatially unique portion of the illuminated scene by determining a frequency of the component signals.

26. The method of claim 25 further comprising splitting the light beam into a transmission portion for illuminating a scene and a local oscillator portion;

27. The method of claim 25 further comprising dynamically varying the frequency chirp in order to vary the range-resolution.

28. A range imaging device comprising:
an illuminating source transmitting an illuminating beam to a scene, wherein the illuminating beam comprises a waveform having a frequency chirp;
mixing optics operable to output a mixed beam, wherein the mixed beam comprises scattered energy from the illuminated scene coherently mixed with a local oscillator beam;
one or more detector elements, wherein each detector element receives a portion of the mixed beam corresponding to a volumetric portion of the illuminated scene, and
wherein each detector element generates an output signal comprising a plurality of components, and wherein each of the components corresponds to the range to a feature appearing in the corresponding volumetric portion of the illuminated scene; and
a signal processor coupled to receive the output signal from each of the one or more detectors, wherein the signal processor determines a frequency of each sinusoidal component to determine a range to the feature corresponding to that component.

29. The device of claim 28 wherein the volumetric portion of the illuminated scene corresponding to any particular detector element is varied by adjusting the chirp rate.
